(19) United States
(12) Patent Application Publication
(10) Pub. No.: US 2016/0220057 A1
(43) Pub. Date: Aug. 4, 2016

(54) COOKING APPLIANCE WITH DIFFERENT MODES FOR COOKING DIFFERENT TYPES OF FOOD PRODUCTS

(71) Applicant: Spectrum Brands, Inc., Middleton, WI (US)

(72) Inventors: Jacob Daniel Smith, Madison, WI (US); Justin Morgan Vaughner, Madison, WI (US); Victor Tenorio Chamixaes Cavalcanti, Madison, WI (US); David William Everett, Verona, WI (US); Gerald Joseph McNerney, Middleton, WI (US); Casey Aaron Klock, Fitchburg, WI (US)

(21) Appl. No.: 14/638,447

(22) Filed: Mar. 4, 2015

Related U.S. Application Data
(60) Provisional application No. 62/110,481, filed on Jan. 31, 2015.

(51) Int. Cl. A47J 27/00; A47J 36/34; A47J 36/02; H05B 3/00; H05B 3/14

(52) U.S. Cl. CPC A47J 27/004; H05B 3/0076; H05B 3/0014; H05B 3/14; A23L 1/0128; A47J 36/02; A47J 36/34

(57) ABSTRACT

A cooking appliance includes a housing defining an interior space, a tray assembly positionable within the interior space, the tray assembly configured to support a food product. The cooking appliance further includes at least one lower heating element positioned below the tray assembly within the interior space, at least one upper heating element positioned above the tray assembly within the interior space, and a controller configured to operate the at least one upper and lower heating elements in accordance with a selected mode of a plurality of selectable modes, wherein operating parameters for the at least one upper and lower heating elements vary between the plurality of selectable modes.

### CROSS-REFERENCE TO RELATED APPLICATIONS

This application claims priority to provisional application Ser. No. 62/110,481, filed Jan. 31, 2015, the entire disclosure of which is incorporated herein.

### BACKGROUND

The present invention relates generally to cooking appliances used for baking foods such as crusted foods, and more particularly to an oven capable of cooking different types of food products relatively quickly and properly.

Cooking appliances such as portable or tabletop cooking appliances that are used for baking crusted-type foods, e.g., breads, pizzas, calzones, and the like, are well known. One drawback associated with at least some known cooking appliances is that they may be designed for only cooking a single type of food product. To cook a single type of food product, an oven may be designed to provide heat energy (e.g., infrared, convection, etc.) in a manner that facilitates optimizing cooking of that single type of food product, but that is inefficient and/or ineffective in cooking different types of food products.

For example, a cooking appliance may be designed to only cook a first type of food product (e.g., frozen pizza). Accordingly, if the same cooking appliance is used to cook a second type of food product (e.g., deep dish pizza), the second type of food product may be cooked improperly (e.g., unevenly heated, underheated, burned, soggy, etc.) in the cooking appliance.

Moreover, at least some known cooking appliances may have relatively long pre-heat times (e.g., 15 minutes or longer). This results in relatively long overall cook times, which are generally undesirable.

There is need, therefore, for cooking appliance (e.g., a pizza oven) that is capable of cooking different types of food products quickly and properly.

### SUMMARY

In one embodiment, a cooking appliance generally comprises a housing defining an interior space, a tray assembly positionable within the interior space, the tray assembly configured to support a food product. The cooking appliance further comprises at least one lower heating element positioned below the tray assembly within the interior space, at least one upper heating element positioned above the tray assembly within the interior space, and a controller configured to operate the at least one upper and lower heating elements in accordance with a selected mode of a plurality of selectable modes, wherein operating parameters for the at least one upper and lower heating elements vary between the plurality of selectable modes.

In another embodiment, a method of cooking a food product positioned on a tray assembly generally comprises receiving the tray assembly and food product in an interior space of a cooking appliance, the cooking appliance including at least one lower heating element positioned below the tray assembly within the interior space, and at least one upper heating element positioned above the tray assembly within the interior space. The method further comprises receiving, at the cooking appliance, a user selection of a mode from a plurality of selectable modes, wherein operating parameters for the at least one upper and lower heating elements vary between the plurality of selectable modes, and cooking the food product in accordance with the user selected mode.

In another embodiment, a pan assembly for use with a cooking appliance generally comprises a rack comprising a frame and a plurality of substantially parallel rods extends across the frame, and a conductive pan coupled to the rack, wherein the conductive pan is coated with a ceramic coating that is both temperature resistant and abrasion resistant.

### BRIEF DESCRIPTION

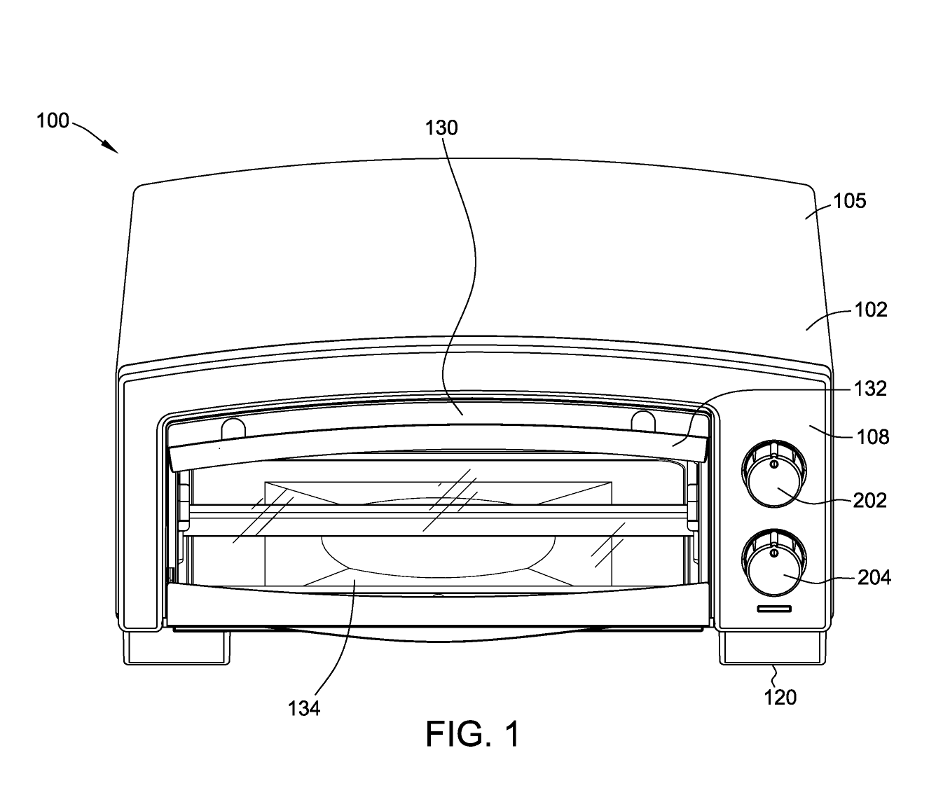

FIG. 1 is a perspective view of a cooking appliance in accordance with one embodiment of the present disclosure;

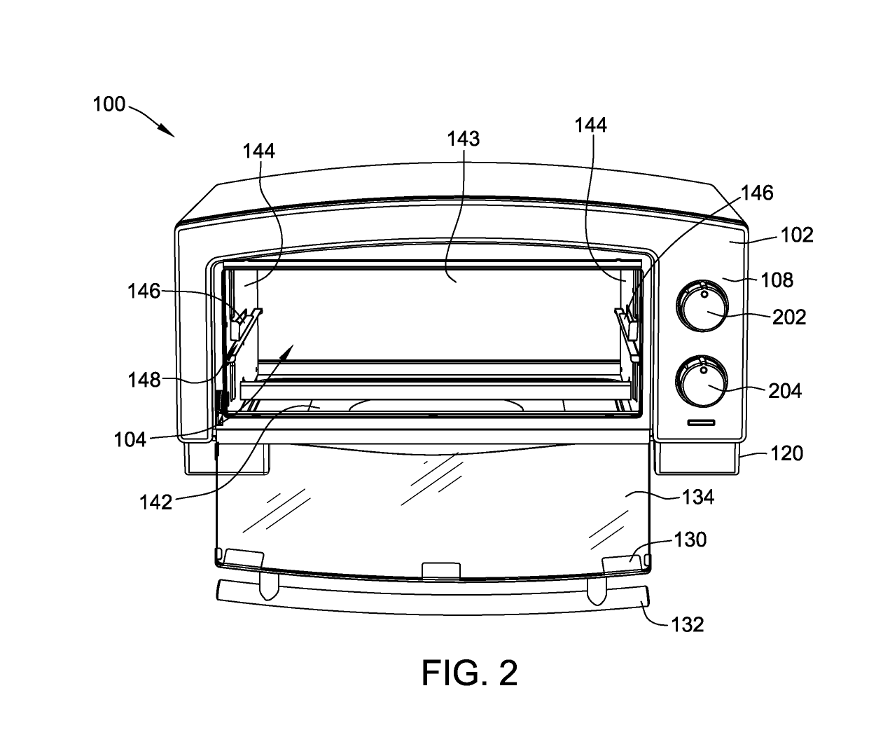

FIG. 2 is a front view of the cooking appliance shown in FIG. 1;

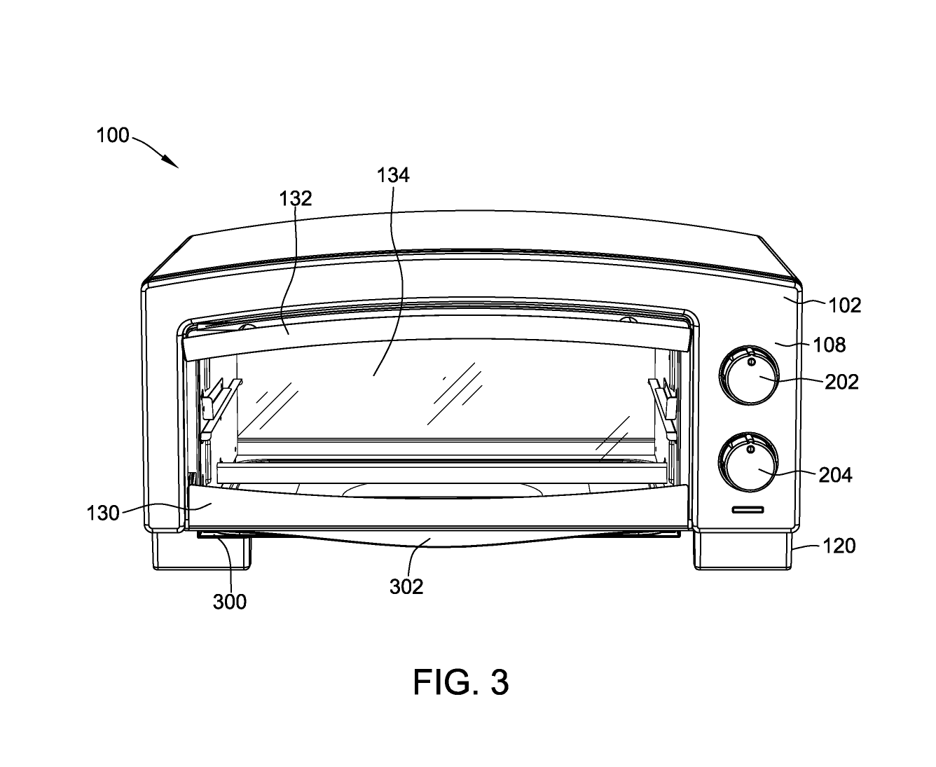

FIG. 3 is a front view of the cooking appliance shown in FIG. 1;

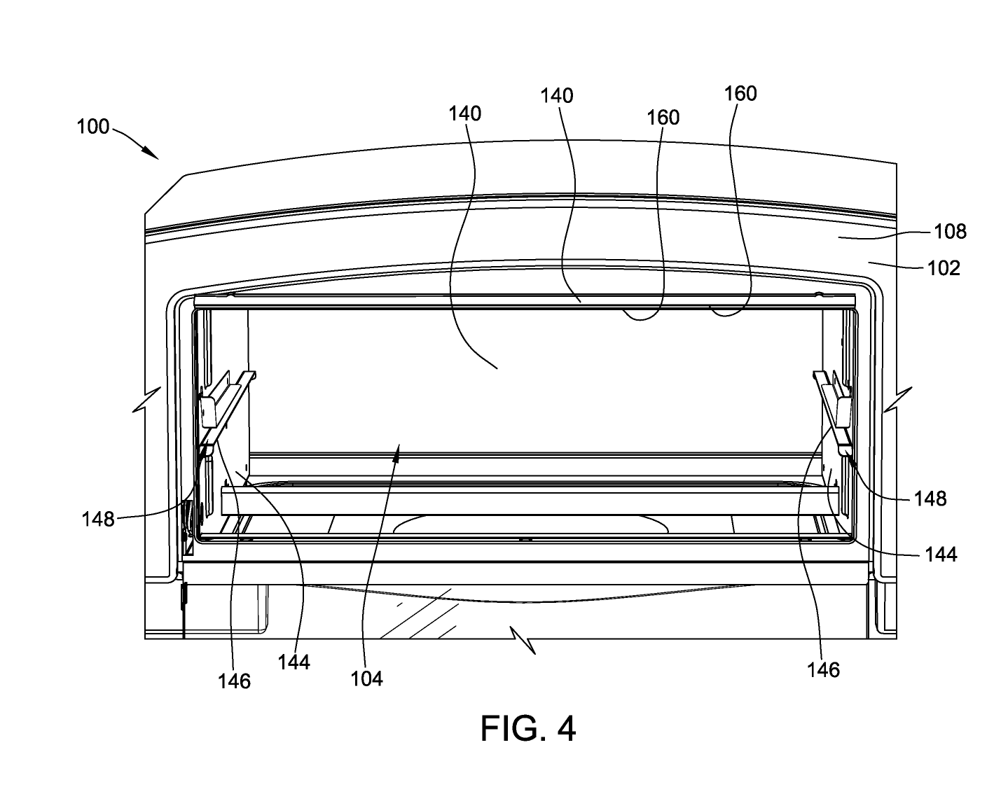

FIG. 4 is a front view of the cooking appliance shown in FIG. 1;

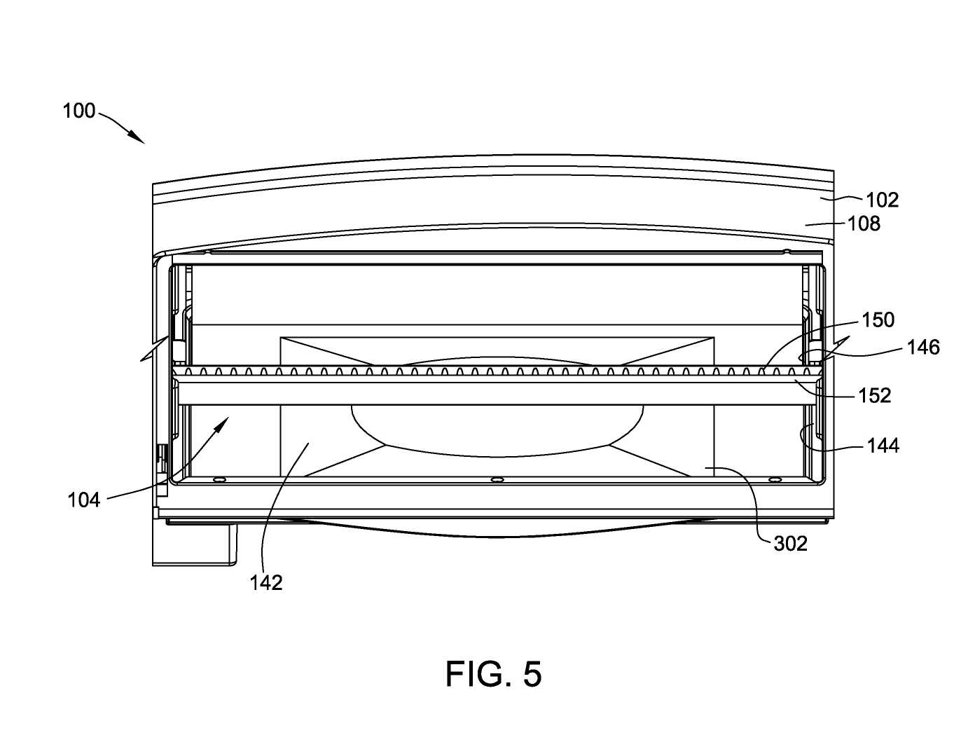

FIG. 5 is a perspective view of a portion of the interior of the cooking appliance shown in FIG. 1;

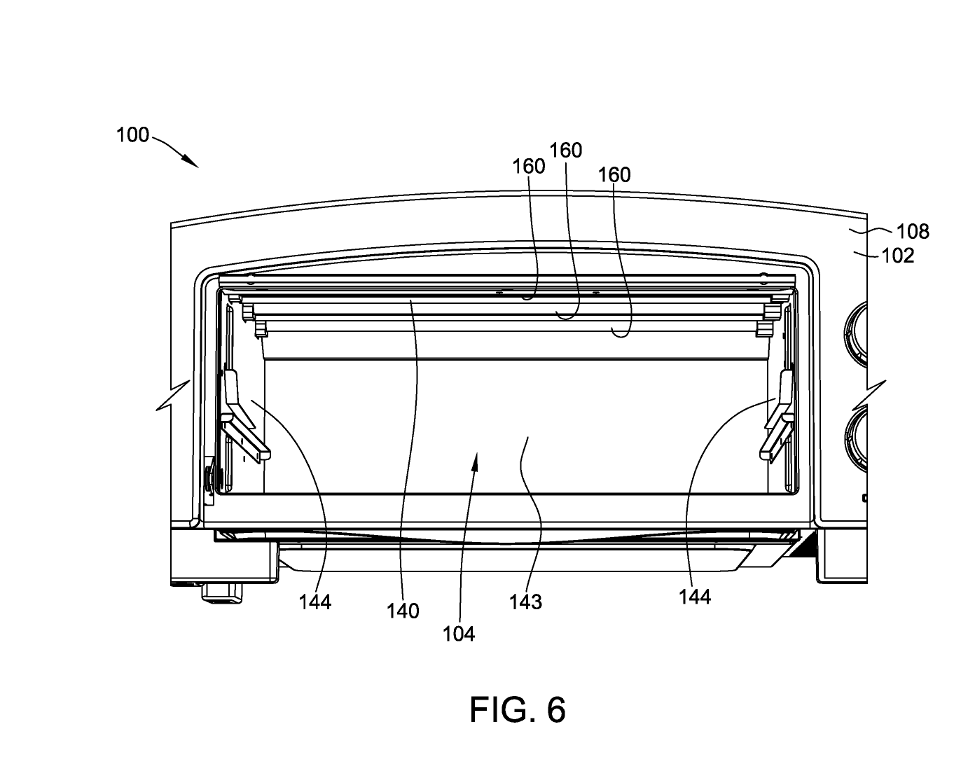

FIG. 6 is a perspective view of a portion of the interior of the cooking appliance shown in FIG. 1;

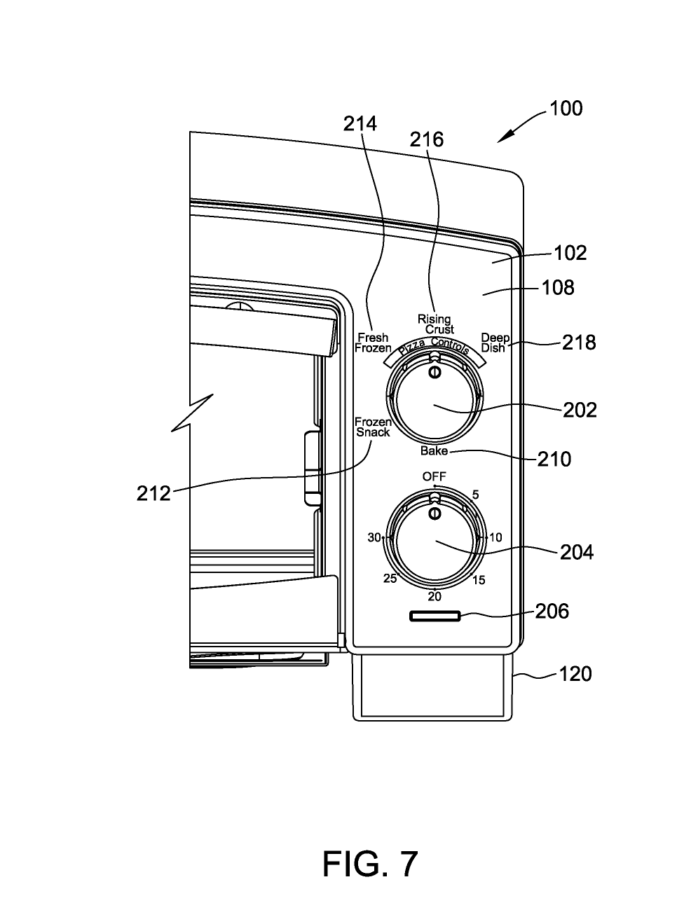

FIG. 7 is a front view of a portion of the cooking appliance shown in FIG. 1;

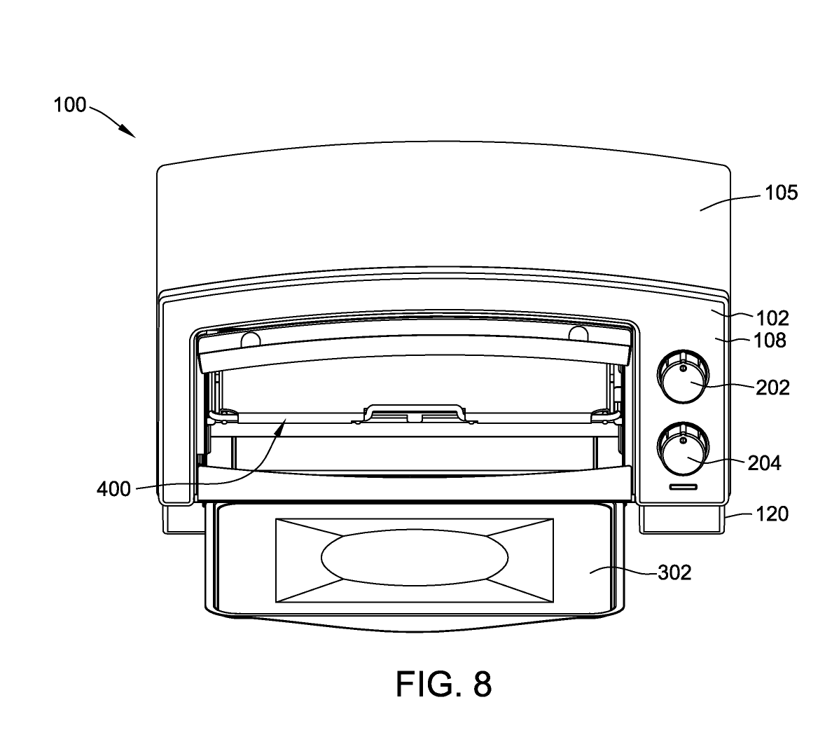

FIG. 8 is a perspective view of the cooking appliance shown in FIG. 1;

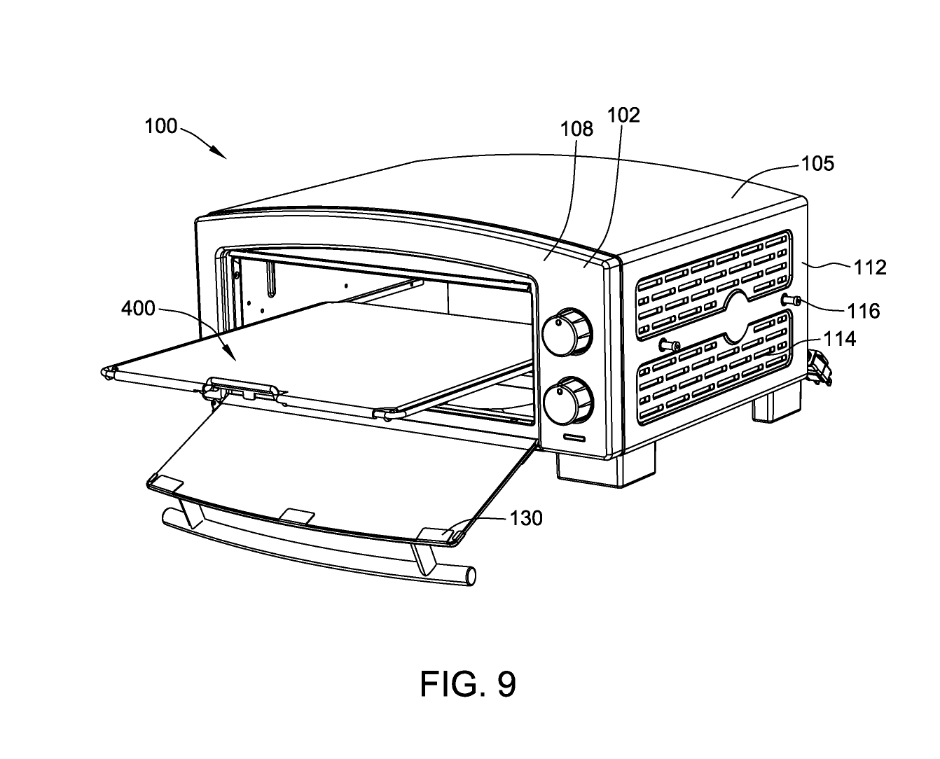

FIG. 9 is a perspective view of the cooking appliance shown in FIG. 1;

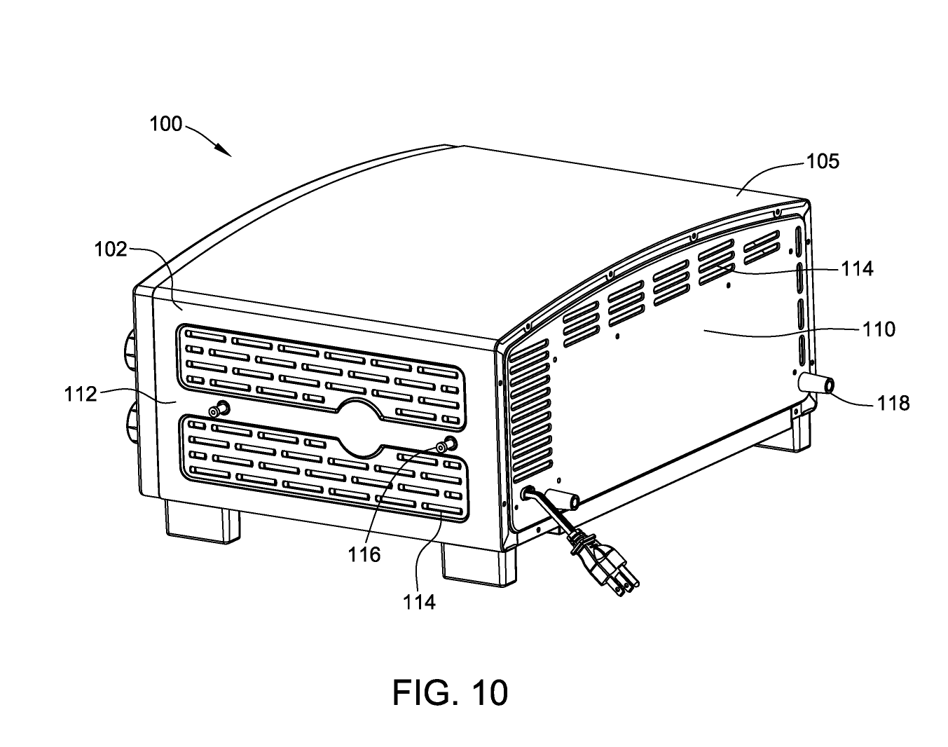

FIG. 10 is a perspective view of the cooking appliance shown in FIG. 1;

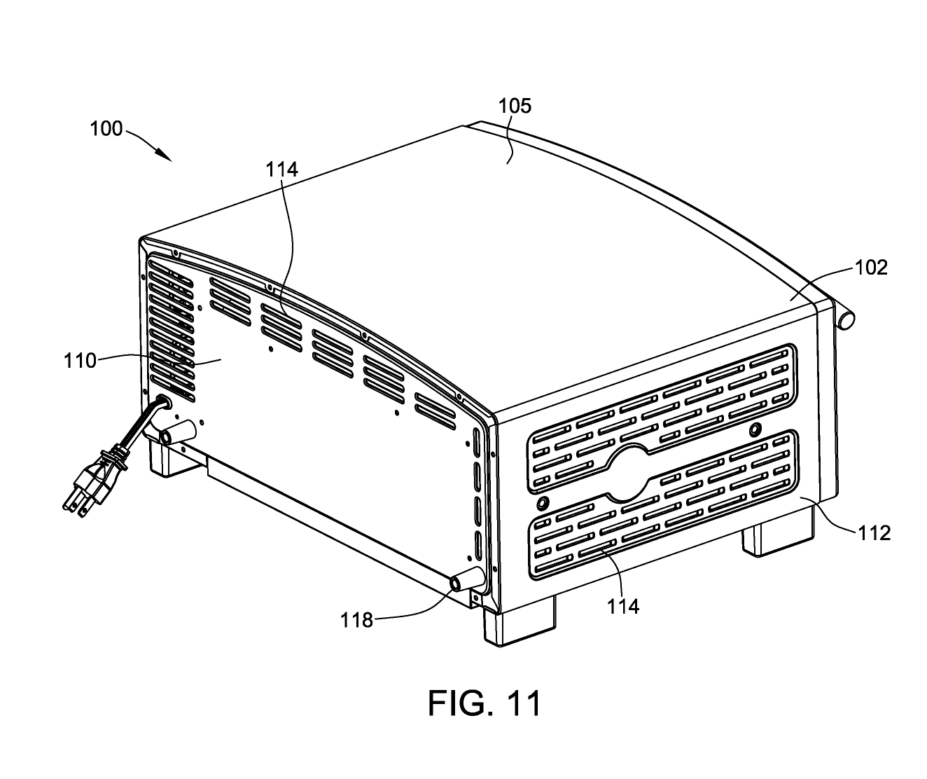

FIG. 11 is a perspective view of the cooking appliance shown in FIG. 1;

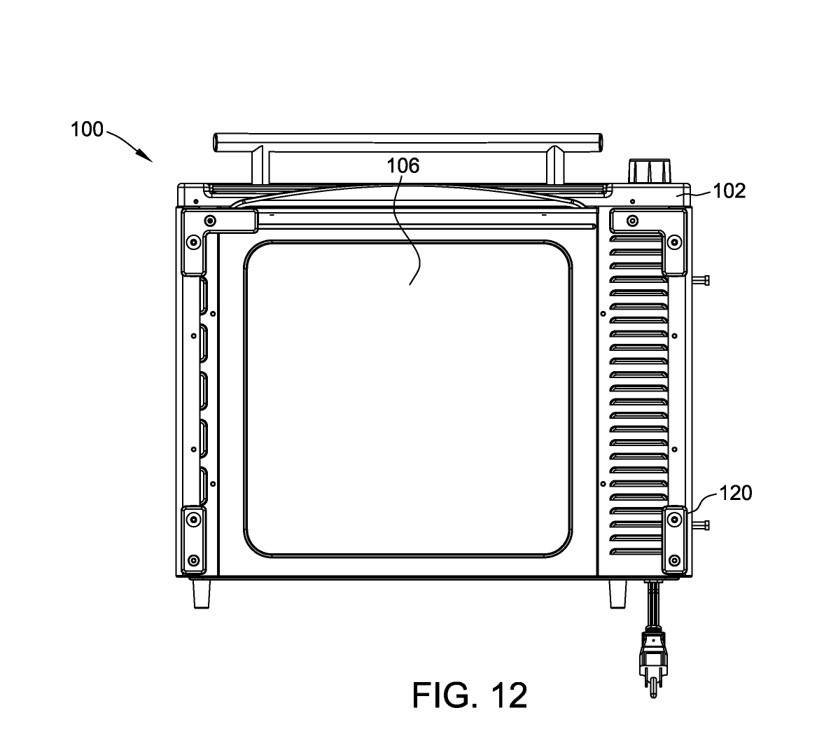

FIG. 12 is a bottom view of the cooking appliance shown in FIG. 1;

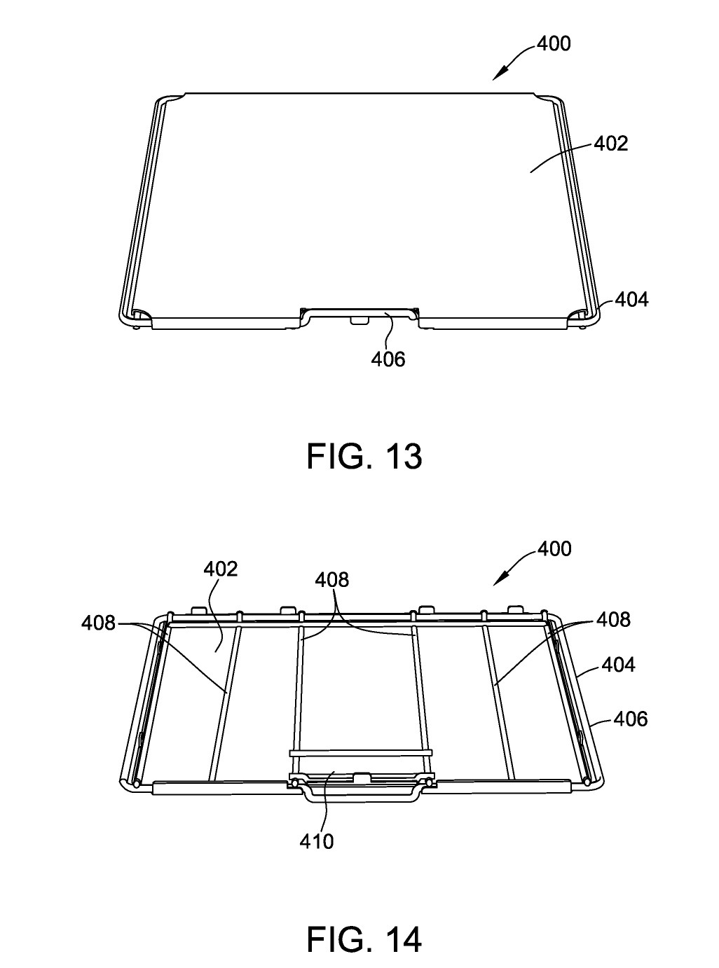

FIG. 13 is a top perspective view of a pan assembly that may be used with the cooking appliance shown in FIG. 1;

FIG. 14 is a bottom perspective view of a pan assembly that may be used with the cooking appliance shown in FIG. 1;

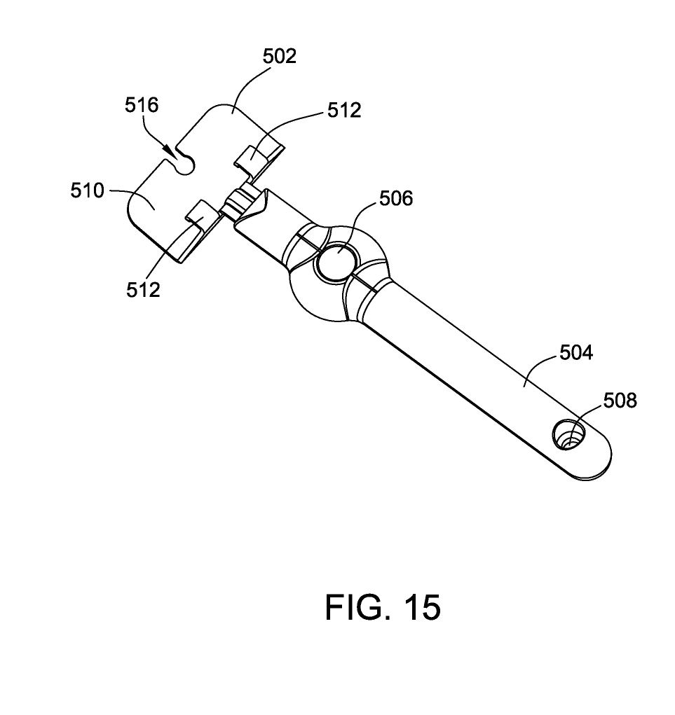

FIG. 15 is a perspective view of a tool that may be used with the pan assembly shown in FIGS. 13 and 14;

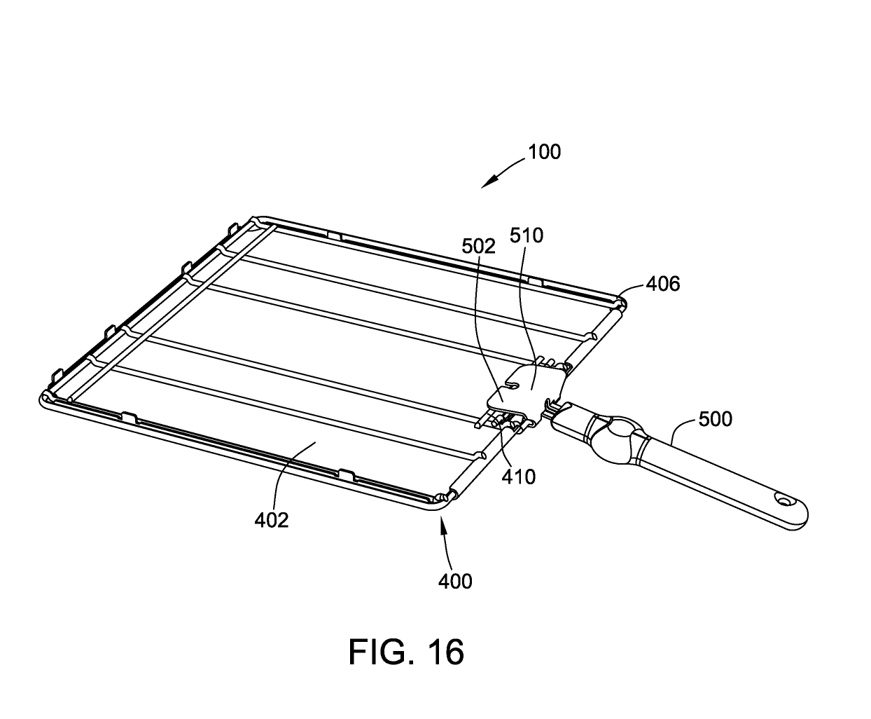

FIG. 16 is a perspective view of the tool shown in FIG. 15 and the pan assembly shown in FIGS. 13 and 14;

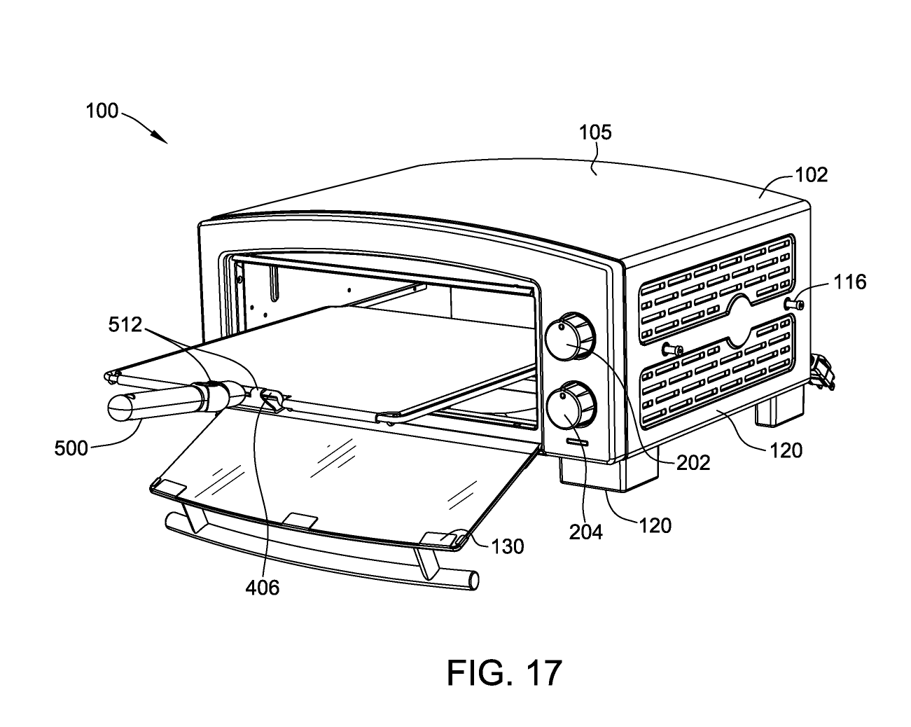

FIG. 17 is a perspective view of the cooking appliance shown in FIG. 1 including the tool shown in FIG. 15 and the pan assembly shown in FIGS. 13 and 14; and

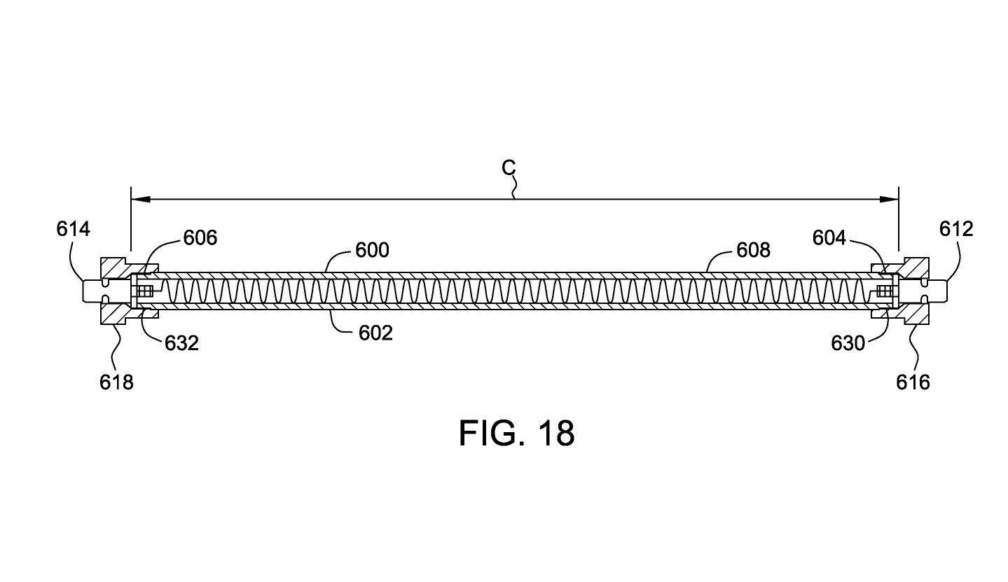

FIG. 18 is a schematic view of one embodiment of a heating element that may be used with the cooking appliance shown in FIG. 1.

Corresponding reference characters indicate corresponding parts throughout the several views of the drawings.

### DETAILED DESCRIPTION

With reference now to the drawings and in particular to FIGS. 1-12, a cooking appliance according to one embodiment of the present disclosure is generally indicated 100. In this embodiment, the cooking appliance 100 is an oven for cooking food products, such as crusted foods (e.g., breads, pizzas, calzones, and the like). For example, the cooking appliance 100 may be a pizza oven. The cooking appliance 100 includes a housing 102 having an interior space 104 defined therein. To cook a food product, the food product is placed within the interior space 104, as described herein.

As shown in FIGS. 1-13, the housing 102 includes a top 105, a bottom 106, a front 108, a back 110, and two sides 112. The back 110 and the sides 112 include vents 114 for dissipating heat generated during operation of the cooking appliance 100. Two hooks 116 extend from at one of the sides 112 to facilitate hooking a tool (not shown in FIGS. 1-13) onto the housing 102. Spacing components 118 extend from the back 110 to facilitate spacing the back 110 at least a predetermined distance from an object or surface (e.g., a wall) when positioning the cooking appliance 100. A set of legs 120 extend from the bottom 106 to support the housing 102 on a surface (e.g., a countertop).

As shown in FIGS. 1-13, a door 130 is pivotably coupled to the front 108 of the housing 102. The door 130 is pivotable between an open position (as shown in FIG. 2) and a closed position (as shown in FIG. 3). In the open position, the interior space 104 is exposed to facilitate inserting and removing a food product from the cooking appliance 100. During cooking, the door 130 is placed in the closed position to facilitate heating the interior space 104. The door 130 includes a handle 132 and a window 134 that enables a user to view the food product during cooking. In this embodiment, the door 130 is pivotably coupled to a lower portion of the front 108. Alternatively, the door 130 may be coupled proximate to an upper portion of the front 108, proximate to at least one side portion of the front 108, and/or coupled to the any portion of the housing 102 using any suitable coupling mechanism that enables the door 130 to function as described herein.

As shown in FIGS. 4-6, the interior space 104 of the cooking appliance is substantially defined by a top surface 140, a bottom surface 142, a back surface 143, and two side surfaces 144. A pan guide 146 is coupled to each side surface 144. Each pan guide 146 defines a means 148 for receiving a pan assembly, as described in detail below. The means may include, for example, a groove, a slot, a shelf, etc.

As shown in FIG. 5, a lower heating element 150 extends between the side surfaces 144, and is positioned proximate the bottom surface 142. In this embodiment, the lower heating element 150 is a halogen heating element. Alternatively, the lower heating element 150 may be any type of heating element that enables cooking appliance 100 to function as described herein. For example, the lower heating element 150 may include a quartz-type heating element, a ceramic-type heating element, a halogen-type heating element, a calrod-type heating element, etc. A means 152 to prevent incidental contact with the lower heating element 150 is also positioned within the interior space 104, and in this embodiment, extends between the side surfaces 144. The means 152 facilitates preventing a user from accidentally contacting and damaging the lower heating element 150 when inserting and removing a food product from the cooking appliance 100. The means may include, for example, a crossbar, a barrier, a flange, and/or any other structure that facilitates preventing a user from contacting the lower heating element 150. Although one lower heating element 150 is shown in FIG. 5, in other embodiments, the cooking appliance 100 may include any number of lower heating elements 150. The lower heating element 150 may have a maximum power output of, for example, up to 2200 Watts (W). For example, in one embodiment, the lower heating element 150 has a maximum power output of 450 W. Further, in some embodiments, the maximum power output may be more than 2200 W.

As shown in FIG. 6, a plurality of upper heating elements 160 extend between the side surfaces 144, and are positioned proximate the top surface 140. In this embodiment, each of the upper heating elements 160 is a quartz-type heating element. Alternatively, the upper heating elements 160 may be any type of heating element that enables cooking appliance 100 to function as described herein. For example, the upper heating elements 160 may include a quartz-type heating element, a ceramic-type heating element, a halogen-type heating element, a calrod-type heating element, etc. Although three upper heating elements 160 are shown in FIG. 6, in other embodiments, the cooking appliance 100 may include any number of upper heating elements 160, including a single upper heating element 160. The upper heating elements 160 may have may have a combined maximum power output of, for example, up to 2200 W. For example, in one embodiment, each of the upper heating elements 160 has a maximum power output of 375 W, for a combined output power of 1125 W. In some embodiments, at least some of the upper heating elements 160 have different maximum power outputs from each other. For example, a front-most or a rear-most upper heating element 160 may have a higher maximum power output than the remaining upper heating elements 160.

In this embodiment, as shown in FIG. 7, the front 108 of the cooking appliance 100 includes a mode selection knob 202 and a timer knob 204. The mode selection knob 202 and timer knob 204 shown in FIG. 7 are examples of input devices for selecting a mode and setting a cook time. Alternative input devices usable with the cooking appliance may include, for example, slide switches, buttons, toggle switches, touch screens, user interfaces, and/or any other type of suitable input device. Further, in some embodiments, a user may select a mode and/or set a cooking time using a computing device (e.g., a tablet, a desktop computer, a laptop computer, a mobile phone, etc.) as the input device, where the computing devices communicates remotely with the oven over a wired and/or wireless network, such as the Internet, or any other communications medium (e.g., Bluetooth®). For example, the user may use a software application on a computing device that enables to input a selected mode and/or set a cooking time, where the input information is communicated from the computing device to the cooking appliance 100. Further, the cooking appliance 100 may communicate information to the computing device (e.g., remaining cook time) to notify the user.

In this embodiment, by rotating the mode selection knob 202, a user can select different modes of operation for the cooking appliance 100 based on the type of food product to be cooked. Specifically, the operation of the lower heating element 150 and the upper heating elements 160 are adjusted based on the selected mode, as described in detail herein. In this embodiment, a controller (e.g., a microcontroller), controls the operation of the lower heating element 150 and the upper heating elements 160 based on the mode selected using the mode selection knob 202. The front 108 of the cooking appliance 100 also includes an indicator 206 (e.g., an LED) that indicates when the cooking appliance 100 is on.

At least one input device (e.g., the mode selection knob 202) enables a user to select a cooking mode from a plurality of selectable cooking modes for the cooking appliance 100. Each of the selectable modes may correspond to, for example, cooking a different type of food product. Although examples of specific modes are described herein, other modes not specifically described are within the spirit and scope of this disclosure.

As shown in FIG. 7, in this embodiment, the selectable modes include a bake mode 210, a frozen snack mode 212, a fresh/frozen mode 214, a rising crust mode 216, and a deep dish mode 218. The fresh/frozen mode 214, the rising crust mode 216, and the deep dish mode 218 are designed for cooking different types of pizza, while the bake mode 210 and the frozen snack mode 212 are designed for cooking other types of food products. Although this embodiment includes five selectable modes, those of skill in the art will appreciate that the cooking appliance 100 may include any suitable number of selectable modes.

Each mode includes an associated set of operating parameters. These operating parameters are designed to facilitate optimizing the cooking of a particular type of food product (i.e., the type of food product corresponding to the mode having the associated operating parameters). Although specific modes and associated operating parameters are described herein, those of skill in the art will appreciate that the cooking appliance 100 may include other modes and/or other operating parameters than those specifically described herein.

In this embodiment, the bake mode 210 and the deep dish mode 218 have the same set of operating parameters. These parameters facilitate improved cooking (e.g., faster and more uniform cooking) of, for example, deep dish pizzas. Specifically, in the bake mode 210 and the deep dish mode 218, once the temperature (as measured by a temperature probe (not shown)) in the interior space 104 reaches 375°, the lower heating element 150 and the upper heating elements 160 are both modulated between being off (e.g., substantially zero power output) and being fully on (i.e., operating at the maximum power output). That is, to maintain a temperature of 375°, the lower heating element 150 and the upper heating elements 160 are either both off or both fully on. The temperature probe may be located, for example, proximate the controller or within the interior space 104.

In this embodiment, the frozen snack mode 212 and the fresh/frozen mode 214 have the same set of operating parameters. These parameters facilitate improved cooking of, for example, fresh and frozen pizza, and other frozen food products (e.g., fish sticks, mozzarella sticks, etc.). Specifically, in frozen snack mode 212 and the fresh/frozen mode 214, once the temperature in the interior space 104 reaches 625°, the lower heating element 150 remains fully on, while the upper heating elements 160 are modulated between being off and being fully on. That is, the upper heating elements 150 are modulated on and off independent of the lower heating element 150, which remains fully on.

In this embodiment, the rising crust mode 216 has a set of associated operating parameters that facilitate improved cooking of, for example, rising crust pizza. Specifically, in the rising crust mode 216, once the temperature in the interior space 104 reaches 625°, the lower heating element 150 remains fully on, while the upper heating elements 160 are modulated between being off and being partially on (i.e., operating at a predetermined percentage of the maximum power output that is less than the maximum power output). For example, the upper heating elements 160 may be modulated between being off and operating at approximately 50% of the maximum power output.

As noted above, other modes and/or operating parameters in addition to those specifically described above are contemplated by the present disclosure. For example, the cooking appliance 100 may include a broil mode, where the lower heating element 150 is off and the upper heating elements 160 are on (i.e., either fully or partially on). In another example, the cooking appliance 100 includes a toast mode, where the lower heating element 150 is partially on and the upper heating elements 160 are fully on. In another example, only some of the upper heating elements 150 are turned on during operation. In yet another example, the lower heating element 150 and/or the upper heating elements 160 may be modulated between being fully on and being partially on. In yet another example, the lower heating element 150 and/or the upper heating elements 160 may be modulated between a first partially on setting (e.g., 75% of the maximum power output) and a second partially on setting (e.g., 25% of the maximum power output).

Referring back to FIG. 3, the front 108 includes a means 300 configured to receive a substantially planar tray 302. The means 300 may include, for example, a slot, a shelf, a groove, and/or other structure for receiving the tray 302. FIG. 8 shows the tray 302 partially inserted into the means 300. The tray 302 catches crumbs, grease, fat, etc. that drops from the food product during cooking. Further, the tray 302 is removable from the cooking appliance 100 for easy disposal of the contents of the tray 302. The tray 302 or a surface of the housing 102 may form the bottom surface 142.

As described above, the pan guides 146 receive a pan assembly. FIG. 8 shows a pan assembly 400 fully inserted into the cooking appliance 100, and FIG. 9 shows the pan assembly 400 partially inserted into the cooking appliance 100. The pan assembly 400 supports the food product during cooking and facilitates uniform heating of the food product, as described herein.

FIG. 13 is a top perspective view of the pan assembly 400, and FIG. 14 is a bottom perspective view of the pan assembly 400. As shown in FIGS. 13 and 14, the pan assembly 400 includes a substantially planar pan 402 coupled to a rack 404. The rack 404 includes a frame 406 and a plurality of substantially parallel rods 408 extending across the frame 406. The pan 402 may be coupled to the rack 404 using any suitable mechanism (e.g., fasteners, a snap-fit connection, welding, etc.). Further, in some embodiments, the pan 402 is not coupled to the rack 404. In this embodiment, the pan assembly 400 is coupled to the rack 404 by crimping edges of the pan 402 over the frame 406. Further, to insert the pan assembly 400 into the interior space 104, portions of the frame 406 are received in the means 148.

A support bar 410 extends between the two innermost rods 408. The support bar 410 facilitates engaging a tool (not shown in FIGS. 13 and 14) for inserting and removing the pan assembly 400 from the cooking appliance 100. In other embodiments, the rack 404 may include structures other than a support bar (e.g., a pin, a flange, etc.) for engaging the tool.

In this embodiment, the pan 402 and the rack 404 are both metallic (e.g., aluminum). Alternatively, the pan 402 and the rack 404 may be made of any suitable conductive material. For example, in some embodiments, the pan 402 and/or rack 404 may be aluminum, steel, copper, ceramic, or glass. The pan 402 and the rack 404 should both be resistant to relatively high temperatures. Further, the rack 404 should have a sufficiently rigid structure and structural integrity to support the pan 402.

To efficiently heat the food product, the pan 402 has a relatively large surface area with a relatively small thickness. For example, in one embodiment, the pan 402 has a thickness of approximately 2 millimeters (mm). Alternatively, the pan 402 may have any thickness that enables the pan 402 to function as described herein. Because of the large surface area and small width, the pan 402 is able to absorb heat from the lower heating element 150 relatively quickly, and transfer that absorbed heat to the food product efficiently and uniformly.

Further, in this embodiment, the pan 402 includes a ceramic coating that provides a nonstick surface, as well as several other advantages. For example, the ceramic coating enables the pan 402 to withstand higher temperatures, as well as be more abrasion resistant. The ceramic coating may also be corrosion resistant. Further, when heated, the ceramic coating emits infrared radiation in a band that is conducive to crisping crust on crusted foods (e.g., pizza). The ceramic coating may include, for example, enamel, porcelain, anodized metal (e.g., aluminum oxide), etc. In some embodiments, the ceramic coating includes an engineered ceramic coating (e.g., ceramic suspended in a binding material). Further, the ceramic coating may have a color tone configured to absorb heat energy. For example, the ceramic coating may have a substantially black color tone.

In some embodiments, the ceramic coating may be a resin ceramic coating (e.g., an organic PTFE resin nonstick coating with a small percentage (e.g., 5-10%) of additive ceramic particles used as reinforcements), a hybrid ceramic coating (e.g., an organic PTFE resin nonstick coating with a large percentage (e.g., 30-40%) of additive ceramic particles used as reinforcements), or a Sol-Gel ceramic coating (e.g., an inorganic coating which goes through a hydrolysis reaction when mixed and baked to create a ceramic layer which is approximately 80-90% ceramic, and which does not contain any PTFE or PFOA).

One possible ceramic coating is, for example, CeraSol SR-STBK01. CeraSol SR-STBK01 used as the ceramic coating may have, for example, an emissivity of 0.905 and an emission power of 4.19×10² Watts per square meter (W/m²).

Moreover, the lower heating element 150 may generate uneven amounts of heat along its length, and the wide, thin configuration of the ceramic coated pan 402 facilitates balancing out the uneven heat to more uniformly and evenly cook the food product. Further, the pan 402 is relatively lightweight, and is able to expand at higher temperatures without restriction to reduce any deformation.

FIG. 15 is a perspective view of one embodiment of a tool 500 that may be used to insert and remove the pan assembly 400 from the cooking appliance. The tool 500 includes a head 502 coupled to a handle 504. In this embodiment, the head 502 is metallic and the handle 504 is an insulating material. The handle 504 includes a depression 506 that receives a user's thumb when the user is holding the handle 504. The handle 504 also includes an aperture 508 defined therethrough to facilitate hanging the tool 500 on the hooks 116.

The head includes a plate member 510 and a pair of prongs 512 that curve towards the plate member 510. As shown in FIGS. 16 and 17, to hold the pan assembly 400 with the tool 500, the tool 500 is maneuvered such that the prongs 512 engage the frame 406 and the plate member 510 engages the support bar 410. The plate member 510 includes a notch 516 that facilitates hanging the tool 500 on the hooks 116. Specifically, one of the hooks extends through the notch 516 and one of the hooks extends through the aperture 508.

The tool 500 is able to be engaged/disengaged with the pan assembly 400 relatively easily by rotating the tool 500 relative to the pan assembly 400. Accordingly, to insert the pan assembly 400 into the cooking appliance 100, the user can engage the tool 500 with the pan assembly 400, insert the pan assembly 400, and then disengage the tool 500 from the pan assembly. Similarly, once cooking is finished, to remove the potentially hot pan assembly 400, the user can engage the tool 500 with the pan assembly 400, and remove the pan assembly 400 from the cooking appliance 100 using the tool 500.

FIG. 18 is a schematic view of a quartz-type heating element 600 that may be used for the upper heating elements 160. The heating element 600 includes a substantially linearly extending tube 602 having a first end 604, a second end 606, and a body 608 extending from the first end 604 to the second end 606 such that the tube 602 has a length C. A filament 610 is disposed within and extends along the length C of the tube 602 substantially from the first end 604 of the tube 602 to the second end 606 of the tube 602. A first electrical lead 612 is connected to the filament 610 near the first end 604 of the tube 602, and a second electrical lead 614 is connected to the filament 610 near the second end 606 of the tube 602.

A first end cap 616 is attached to the first end 604 of the tube 602 about the first electrical lead 612 such that the first electrical lead 612 passes through (i.e., is supported within and extends outward from) the first end cap 616. Similarly, a second end cap 618 is attached to the second end 606 of the tube 602 about the second electrical lead 614 such that the second electrical lead 614 passes through (i.e., is supported within and extends outward from) the second end cap 618. In this manner, the first end cap 616 supports the first electrical lead 612, and the second end cap 618 supports the second electrical lead 614. Moreover, the end caps 616, 618 are useful in connecting the heating element 600 to the side surfaces 144. Suitably, a first insulator 630 is sandwiched between the first end cap 616 and the tube 602, and a second insulator 632 is sandwiched between the second end cap 618 and the tube 602. The insulators 630, 632 facilitate insulating the end caps 616, 618 against conductive heat transfer from the tube 602 to the end caps 616, 618 when the heating element 600 is energized by passing electrical current through the filament 610 via the electrical leads 612, 614.

In this embodiment, the end caps 616, 618 are fabricated from a ceramic material, and the filament 610 is fabricated from a tungsten material or nickel-chromium-iron composite material. Moreover, the filament 610 is a coiled wire in the illustrated embodiment, with the diameter of each coil and the number of coils being selectable to suit a desired wattage of the heating element 600 and to suit a desired amount of infrared energy emitted from the heating element 600 when the heating element 600 is energized. In that regard, the tube 602 is fabricated from a quartz glass material that may be transparent, translucent (e.g., frosted), or at least partially coated with a reflective material (e.g., a metallic material) to suit a desired amount (and direction) of infrared energy transmitted through the tube 602. Notably, in other embodiments, the heating element 600 may be configured in any suitable manner that facilitates enabling the heating element 600 to function as described herein (e.g., the filament 610 of the heating element 600 may not be coiled in some embodiments, or in other embodiments the tube 602 may not extend linearly but, rather, may extend along a curvilinear path).

Moreover, the space surrounding the filament 610 within the tube 602 is open (i.e., the inside of the tube 602 is either under vacuum with gas, or not sealed and exposed to the ambient air). As such, infrared energy emitted from the energized filament 610 is permitted to travel from the filament 610 through the tube 602 with minimal obstruction in some embodiments). Such a configuration of the heating element 600 is distinguishable from a calrod-type configuration in which a filament is surrounded by a powdered material and packed within a metal tube such that infrared energy emitted from the filament is obstructed and absorbed by the powdered material in order to heat the metal tube via conduction.

As such, the quartz-type heating element 600 disclosed herein provides heating properties that are superior to a calrod-type heating element. For example, the quartz-type heating element 600 emits more infrared energy in a more focused manner to facilitate quicker heat-up and better control of energy incidence onto a food product in cooking appliance 100 (e.g., to enable rapid cycling of the amount of infrared energy incidence onto the food product). As such, the quartz-type heating element 600 disclosed herein permits the cooking appliance 100 to be used in a plurality of alternate configurations to heating a food product in a ways that would not be effective (or practical) via a calrod-type heating element (e.g., broiling a food product using the upper heating elements 160 would not be effective or practical using a calrod-type heating element). Notably, in alternative embodiments of the cooking appliance 100, the upper and lower heating elements 150 and 160 may each be any suitable type of heating element other than a quartz-type heating element, such as, for example, a ceramic-type heating element, a halogen-type heating element, a calrod-type heating element, etc.

The cooking appliances described herein provide multiple heating modes for cooking different types of food products (e.g., different types of pizza). By selecting a mode that corresponds to a type of food product to be cooked, the cooking appliances described herein are able to adjust upper and lower heating elements to facilitate improved cooking of that type of food product. As compared to at least some known cooking appliances, the cooking appliances described herein cook a food product more quickly, and more uniformly. Further, the pan assemblies described herein are configured for use at higher temperatures than at least some known cooking pans, and provide more uniform cooking of food products than at least some known cooking pans. Moreover, the cooking appliances described herein facilitate improving the crispiness of crusted food products.

By using different modes for different food product (e.g., by controlling upper and lower heating elements independently), the amount of heat energy emitted to the food product can be controlled, improving cooking results. That is, in the embodiments described herein, the cooking mode of the cooking appliance can be modified to address differences in the type of food product being cooked by changing the configuration of energy (e.g., convection, infrared, etc.) being delivered to the food product.

Moreover, by controlling energy delivery to a food product as described herein, the cooking appliances disclosed have substantially reduced pre-heat times, relative to at least some known cooking appliances. Accordingly, unlike at least some known cooking appliances, the systems and methods described herein enable cooking different types of food products efficiently and properly using the same cooking appliance.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A cooking appliance comprising:
a housing defining an interior space;
a tray assembly positionable within the interior space, the tray assembly configured to support a food product;
at least one lower heating element positioned below the tray assembly within the interior space;
at least one upper heating element positioned above the tray assembly within the interior space; and
a controller configured to operate the at least one upper and lower heating elements in accordance with a selected mode of a plurality of selectable modes, wherein operating parameters for the at least one upper and lower heating elements vary between the plurality of selectable modes.

2. The cooking appliance of claim 1, wherein each of the plurality of selectable modes is associated with cooking a different type of food product.

3. The cooking appliance of claim 1, wherein the plurality of selectable modes include:
a first mode in which the at least one lower heating element and the at least one upper heating element are both modulated between being off and being fully on to maintain a first predetermined temperature in the interior space;
a second mode in which the at least one lower heating element is fully on, and the at least one upper heating element is modulated between being off and being fully on to maintain a second predetermined temperature in the interior space; and
a third mode in which the at least one lower heating element is fully on, and the at least one upper heating element is modulated between being off and being partially on to maintain a third predetermined temperature in the interior space.

4. The cooking appliance of claim 1, wherein the at least one upper heating element includes a plurality of upper heating elements, and wherein the plurality of selectable modes include at least one mode in which less than all of the plurality of upper heating elements are on.

5. The cooking appliance of claim 1, wherein the plurality of selectable modes include at least one mode in which at least one of the at least one lower heating element and the at least one upper heating element are modulated between being off and being partially on to maintain a predetermined temperature.

6. The cooking appliance of claim 1, wherein the plurality of selectable modes include at least one mode in which one of the at least one lower heating element and the at least one upper heating element is fully on, and in which the other of the at least one lower heating element and the at least one upper heating element is off.

7. The cooking appliance of claim 1, wherein the plurality of selectable modes include at least one mode in which one of the at least one lower heating element and the at least one upper heating element is fully on, and in which the other of the at least one lower heating element and the at least one upper heating element is partially on.

8. The cooking appliance of claim 1, wherein the at least one lower heating element is a halogen heating element, and wherein the at least one upper heating element is a quartz-type heating element.

9. The cooking appliance of claim 1, wherein the at least one lower heating element is a halogen heating element.

10. The cooking appliance of claim 1, wherein the at least one upper heating element is a quartz-type heating element.

11. The cooking appliance of claim 1, further comprising a mode select knob that enables a user to choose the selected mode.

12. The cooking appliance of claim 1, further comprising an input device that enables a user to choose the selected mode.

13. The cooking appliance of claim 1, wherein the cooking appliance is configured to receive the selected mode based on a user input made at a computing device that communicates with the cooking appliance over a wired or wireless network.

14. The cooking appliance of claim 1, wherein the plurality of selectable modes includes a deep dish pizza mode, a rising crust pizza mode, and a fresh/frozen pizza mode.

15. A method of cooking a food product positioned on a tray assembly, the method comprising:
receiving the tray assembly and food product in an interior space of a cooking appliance, the cooking appliance including at least one lower heating element positioned below the tray assembly within the interior space, and at least one upper heating element positioned above the tray assembly within the interior space;
receiving, at the cooking appliance, a user selection of a mode from a plurality of selectable modes, wherein operating parameters for the at least one upper and lower heating elements vary between the plurality of selectable modes; and
cooking the food product in accordance with the user selected mode.

16. The method of claim 15, wherein receiving a user selection of a mode comprises receiving a user selection of a mode from a plurality of modes each associated with cooking a different type of food product.

17. The method of claim 15, wherein receiving a user selection of a mode comprises receiving a user selection of a mode from a plurality of modes that include:
a first mode in which the at least one lower heating element and the at least one upper heating element are both modulated between being off and being fully on to maintain a first predetermined temperature in the interior space;
a second mode in which the at least one lower heating element is fully on, and the at least one upper heating element is modulated between being off and being fully on to maintain a second predetermined temperature in the interior space; and
a third mode in which the at least one lower heating element is fully on, and the at least one upper heating element is modulated between being off and being partially on to maintain a third predetermined temperature in the interior space.

18. The method of claim 15, wherein receiving a user selection of a mode comprises receiving a user selection of a mode from a plurality of modes that include at least one mode in which at least one of the at least one lower heating element and the at least one upper heating element are modulated between being off and being partially on to maintain a predetermined temperature.

19. The method of claim 15, wherein receiving a user selection of a mode comprises receiving a user selection of a mode from a plurality of modes that include at least one mode in which one of the at least one lower heating element and the at least one upper heating element is fully on, and in which the other of the at least one lower heating element and the at least one upper heating element is off.

20. The method of claim 15, wherein receiving a user selection of a mode comprises receiving a user selection of a mode from a plurality of modes that include at least one mode in which one of the at least one lower heating element and the at least one upper heating element is fully on, and in which the other of the at least one lower heating element and the at least one upper heating element is partially on.

21. The method of claim 15, wherein receiving a user selection of a mode comprises receiving a user selection of a mode from an input device operated by the user.

22. A pan assembly for use with a cooking appliance, the pan assembly comprising:
a rack comprising a frame and a plurality of substantially parallel rods extends across the frame; and
a conductive pan coupled to the rack, wherein the conductive pan is coated with a ceramic coating that is both temperature resistant and abrasion resistant.

23. The pan assembly of claim 22, wherein the conductive pan is coupled to the rack by crimping edges of the pan over the frame.

24. The pan assembly of claim 22, wherein the rack further comprises a support bar extending between a pair of rods of the plurality of substantially parallel rods, the support bar configured to engage a tool for holding the pan assembly.

25. The pan assembly of claim 22, wherein the frame is configured to engage a pair of prongs on the tool.

26. The pan assembly of claim 22, wherein the rack is a steel rack, wherein the pan is an aluminum pan coated with a black-toned CeraSol SR-STBK01 ceramic coating, and wherein the pan has a thickness of approximately 2 millimeters.
